(19) United States
(12) Patent Application Publication
(10) Pub. No.: US 2019/0142559 A1
(43) Pub. Date: May 16, 2019

(54) TOOTH CLEANING APPLIANCE

(71) Applicant: Yan SUN, SARATOGA, CA (US)

(72) Inventor: Yan SUN, SARATOGA, CA (US)

(21) Appl. No.: 15/809,056

(22) Filed: Nov. 10, 2017

(51) Int. Cl. A61C 17/22; A61C 17/02; A61C 15/04; A61C 17/30

(52) U.S. Cl. CPC A61C 17/228; A61C 17/0211; A61C 17/20; A61C 17/30; A61C 15/046

(57) ABSTRACT

Disclosed are improved apparatus, structures and methods for tooth cleaning using mouthpiece appliance(s), water jets, brushes, and sonics/ultrasonics as shown and described.

### TECHNICAL FIELD

This disclosure relates generally to dental hygiene and more particularly to an apparatus for tooth cleaning.

### BACKGROUND

As will be readily appreciated by those skilled in the art, tooth decay and periodontal disease may result from traditional, unsatisfactory hand brushing methods that result in an ineffective removal of residue and/or dental plaque.

Given the importance of proper dental hygiene an improved tooth cleaning appliance that is convenient, economical and effective would represent a welcome addition to the art.

### SUMMARY

An advance in the art is made according to an aspect of the present disclosure directed to a convenient, efficient, economical and effective tooth cleaning appliance.

In sharp contrast to the prior-art, appliances, structures, methods and techniques according to the present disclosure use mouthpiece appliance(s), water jets, brushes, and sonics/ultrasonics as shown and described to produce an effective and inexpensive cleaning appliance that may be custom made and or fit to a particular user according to her particular dental hygiene requirements.

### BRIEF DESCRIPTION OF THE DRAWING

A more complete understanding of the present disclosure may be realized by reference to the accompanying drawing in which:

FIG. 1 shows a schematic diagram depicting an illustrative tooth cleaning appliance according to an aspect of the present disclosure;

FIG. 2 shows a schematic cross-section of a tooth cleaning appliance and more particularly integrated water channels directed to specific gum/tooth areas for cleaning according to an aspect of the present disclosure;

FIG. 3 shows a schematic perspective view of a tooth cleaning appliance including integrated lower and upper portions with multiple water pipes and outlets according to an aspect of the present disclosure;

FIG. 4 shows a schematic side view of a tooth cleaning appliance including integrated upper and lower portions, water pipe, water channels and outlets according to an aspect of the present disclosure;

FIG. 5 shows a schematic perspective view of a tooth cleaning appliance including floss lines for using dental floss while the appliance is inserted in a user's mouth according to an aspect of the present disclosure;

FIG. 6 shows a schematic diagram illustrating various spray/jet patterns that may be generated from various slit configurations for water jets according to an aspect of the present disclosure;

FIG. 7(a), FIG. 7(b) and FIG. 7(c) show a series of schematic diagrams depicting various brush arrangement configurations according to an aspect of the present disclosure;

FIG. 8 is a schematic diagram illustrating an appliance according to the present disclosure used in conjunction with a water reservoir/pump system to provide a water flow to the appliance.

### DETAILED DESCRIPTION

The following merely illustrates the principles of the disclosure. It will thus be appreciated that those skilled in the art will be able to devise various arrangements which, although not explicitly described or shown herein, embody the principles of the disclosure and are included within its spirit and scope. More particularly, while numerous specific details are set forth, it is understood that embodiments of the disclosure may be practiced without these specific details and in other instances, well-known circuits, structures and techniques have not been shown in order not to obscure the understanding of this disclosure.

Furthermore, all examples and conditional language recited herein are principally intended expressly to be only for pedagogical purposes to aid the reader in understanding the principles of the disclosure and the concepts contributed by the inventor(s) to furthering the art, and are to be construed as being without limitation to such specifically recited examples and conditions.

Moreover, all statements herein reciting principles, aspects, and embodiments of the disclosure, as well as specific examples thereof, are intended to encompass both structural and functional equivalents thereof. Additionally, it is intended that such equivalents include both currently-known equivalents as well as equivalents developed in the future, i.e., any elements developed that perform the same function, regardless of structure.

Thus, for example, it will be appreciated by those skilled in the art that the diagrams herein represent conceptual views of illustrative structures embodying the principles of the disclosure.

Thus, for example, it will be appreciated by those skilled in the art that the diagrams herein represent conceptual views of illustrative structures embodying the principles of the disclosure.

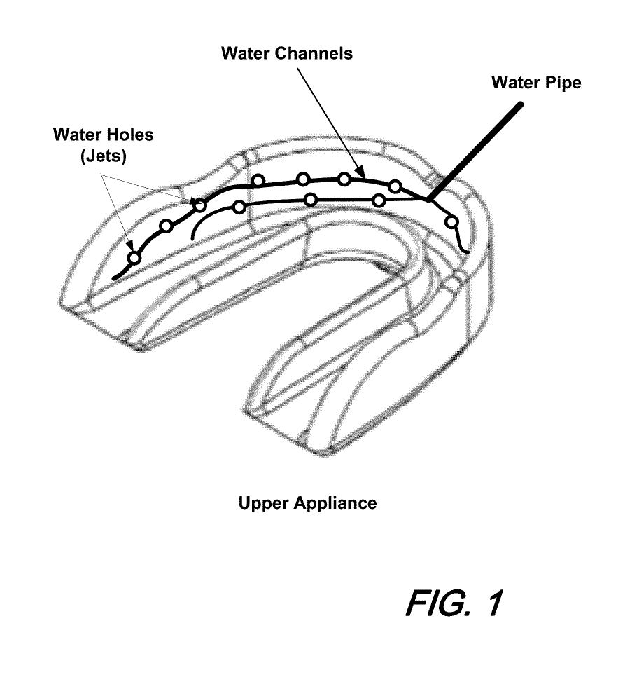

FIG. 1 is a schematic diagram depicting an illustrative tooth cleaning appliance(s) according to aspects of the present disclosure. More particularly, shown in that FIG. 1 is a portion of an illustrative tooth cleaning appliance that when placed in the mouth of an individual and a flow of water is made to enter the mouthpiece via waterpipe, the water will flow through and around the mouthpiece via pre-defined water channels such that the flow(s) contact the teeth. The flow so created will advantageously flow around and between the teeth thereby cleaning both the teeth and the gums of the individual.

As may be readily appreciated by those skilled in the art, the appliance shown schematically in FIG. 1 may be applied to upper teeth, lower teeth, or both—if so configured. Furthermore, an appliance like that shown—according to the present disclosure—may advantageously be fabricated to fit an individual's particular teeth, or be more generic to fit any of a number of individuals. Still further, an appliance such as that shown in FIG. 1 according to the present disclosure may be fabricated by any of a variety of known molding and/or fabrication techniques as well as any of a number of known bio-compatible materials including polymeric one(s). Finally, contemporary imaging and/or 3D printing/fabrication technologies may be employed to readily construct any of a number of individualized appliances for a particular individual or application.

Of particular interest to those skilled in the art, a particular individual's unique dental geometries may be readily accommodated by such individualized fabrication and individual dental layout/geometry may be considered when fabricating. In particular, specific layout, direction, volume of channels/jets (not specifically shown in FIG. 1) may be included to more directly and particularly affect an individuals mouth and/or teeth and/or spaces/gaps between same.

Still further, particular water channels may be fabricated to circumferentially clean teeth—or individual ones or spaces—thereby cleaning an entire surface or area of an individual's mouth/teeth/gums, etc. Additionally, such customization may permit the tailoring of specific flow to accommodate an individual including those that are particularly prone to plaque or are particularly sensitive to aggressive cleaning.

Advantageously, appliances according to the present disclosure permit a wide variety of channel design and configurations—including material choices. More particularly, particular channels or portions thereof may be wider, narrower, flatter, rounder, etc., than other portions of a channel or other channels or portions of channels. Still further, channels or portions thereof may exhibit different curvatures, flow controls (obstructions), directions of flow etc., and chosen and configured in such a manner as to permit a desirable water flow direction, speed, shape, pressure, etc. As will become more apparent to those skilled in the art, such configurations of channels in conjunction with slit/jet/nozzle configuration(s) permit a limitless variety of configurations which may advantageously be tailored to an individual circumstance and dental needs.

Finally, it is noted that while we frequently refer to a flow or jet of water with respect to appliances, it should be readily understood and appreciated by those skilled in the art that we are not necessarily limited to continuous flows. More specifically, pulsing water flows may be advantageous in particular circumstances and such pulse flows, bursts or intermittent flows may be readily achieved by using appropriately chosen or controlled pumps and/or valve systems to provide such desirable flow/pulse characteristics.

It should be noted that the illustrative appliance shown in FIG. 1 may include as an integrated whole both upper and lower appliance(s)—those that clean both upper and lower teeth simultaneously. Such configuration(s) may include one or more water pipes for both upper and lower, or they may share a common water pipe as appropriate.

As may be appreciated by those skilled in the art, a tooth cleaning appliance according to the present disclosure—when so configured—may clean both upper and lower teeth simultaneously, is less messy and conventional hand-held, “pik” type appliances and is easy to use with no individualized training or skill required.

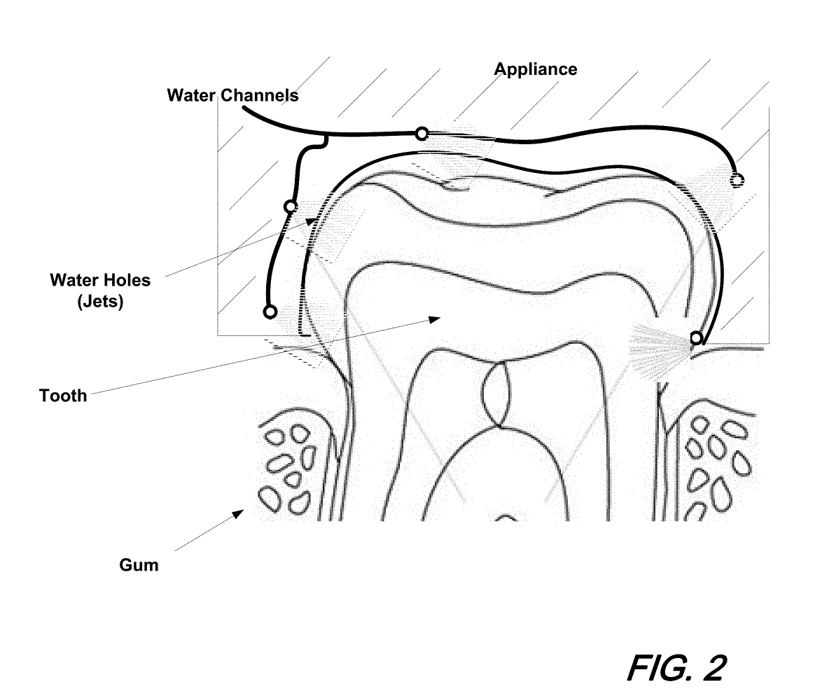

Turning now to FIG. 2, there it shows a schematic cross sectional view of a tooth cleaning appliance according to aspects of the present disclosure. As may be observed from that FIG. 2, the cleaning appliance is sized appropriately and fits sufficiently snug around exposed surface(s) of teeth such that water jets emerging from the water channels noted with respect to FIG. 1, will be directed at surface(s) of the teeth as well as gums and gaps between the teeth. As may be understood, these water jets may be customized for individuals exhibiting unique dental geometries and/or problems.

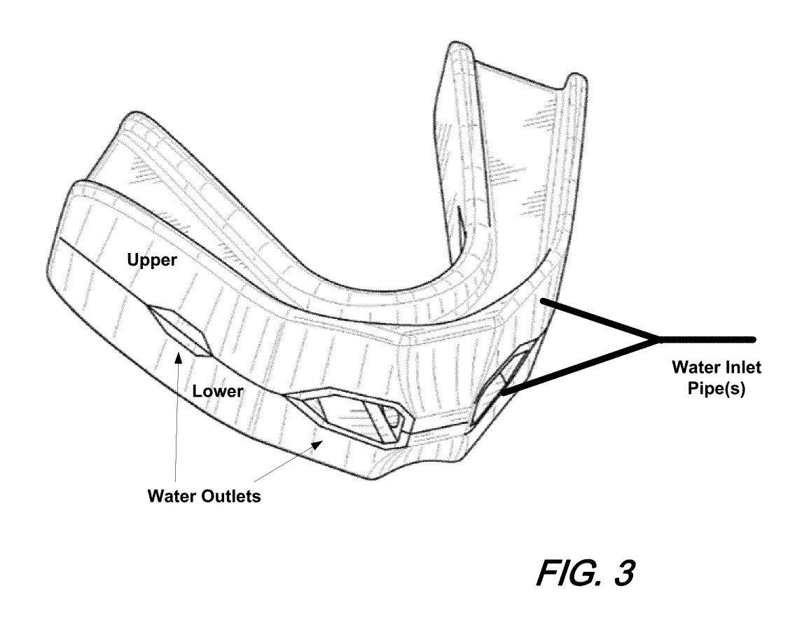

FIG. 3 is a perspective view of an illustrative tooth cleaning appliance according to the present disclosure wherein upper and lower sections are fabricated as an integrated whole. Shown further in that FIG. 3 are water pipes connecting a water source to the appliance into which is directed a flow of water. As may be observed in FIG. 3, openings spaced appropriately around the appliance permits the outflow of water from an individual user's mouth. As may be appreciated, the specific size, spacing and location(s) of the openings may be varied as an individual user requires. Also, such size, orientation and placement of the openings may advantageously affect the internal pressure(s) of the water within the appliance thereby producing different, desirable cleaning effect(s).

It is worth noting that careful design may advantageously permit the appliance to exhibit an equal pressure characteristics at various water jets spaced throughout the appliance. Conversely, such design may advantageously permit the appliance to exhibit unequal pressure(s) at various water jets to—for example—apply more vigorous cleaning at particular areas of the teeth or gums—or particular teeth—as appropriate and/or desired.

It is also worth noting at this point that the figures are only illustrative, and specific configurations or combinations of configurations are contemplated herein and as will be appreciated by those skilled in the art. More particularly, the illustrative configuration of an appliance shown in FIG. 3 is shown with a smooth upper and lower surface(s). Of course, such surfaces may be shaped, contoured or otherwise configured to any of a variety of shapes as required for effectiveness, comfort, convenience and/or manufacture. In particular, the smooth surface(s) so referenced may be notched or otherwise shaped as shown in other figures included herein or contemplated by those skilled in the art.

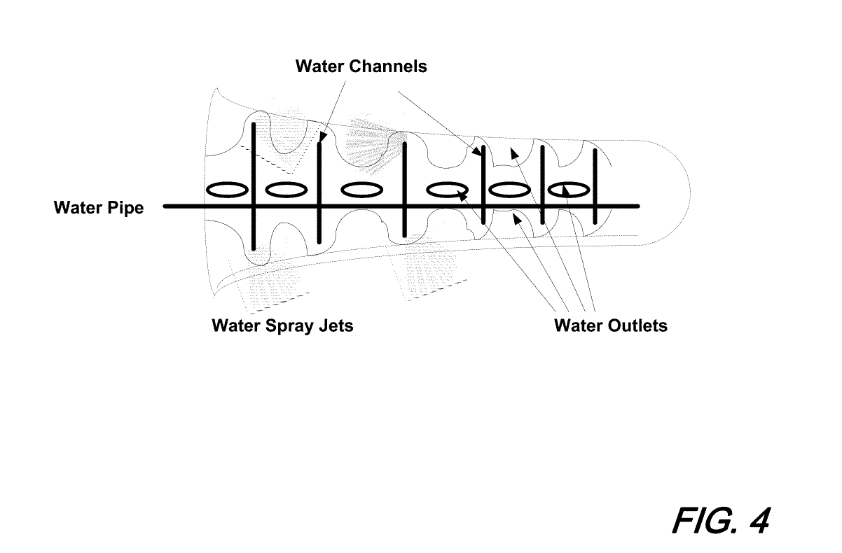

FIG. 4 shows a schematic side view of a tooth cleaning appliance according to an aspect of the present disclosure including an integrated upper and lower portion(s) along with an input water pipe and water channels formed throughout the appliance as well as outlets spaced along a perimeter of the appliance. As may be readily understood from this FIG. 4, water may enter the appliance via the water pipe and be distributed to specific locations by the water channels where it exits the channels as jets of water to clean teeth/gums/etc proximate to the jets. Afterwords, the water is expelled through the outlets. Readily apparent from this FIG. 4, the water channels and jets may be designed to impact particular teeth and/or areas.

Notably, while the appliance shown in FIG. 4 exhibited a one-piece, integrated structure, appliances according to the present disclosure are not so limited. More particularly, tooth cleaning appliances according to the present disclosure may be two (or more) pieces. Additionally, there are circumstances where an individual may only—for example—use an upper appliance and clean only upper teeth and gums. Likewise, there are circumstances when an individual my only use a lower appliance and clean only lower teeth and gums. Additionally, different configurations may allow a user to select a particular appliance for a given use and change the appliance for another use. In this inventive manner, individualized, per-use customization is possible when using appliances according to the present disclosure. While such per-use configuration may be at times inconvenient to switch-out a particular appliance or component thereof—the individualized nature of the appliances is believed to greatly outweigh any minor inconvenience(s).

Note further with respect to FIG. 4, that water outlets may include one or more outlet holes as illustratively depicted in FIG. 4, or may be outlet via shapes in the appliance as shown further. More particularly, water may be outlet from the appliance after spraying via the “troughs” inbetween the “peaks” shown in the FIG. 4. Note further that such configuration is only illustrative, and any of a variety of configurations are contemplated herein.

Advantageously, tooth cleaning appliances according to the present disclosure—given their variety of configurations—provide ease of manufacture and may provide long-lasting water jets providing uniformity of water speed/volume across any number of jets.

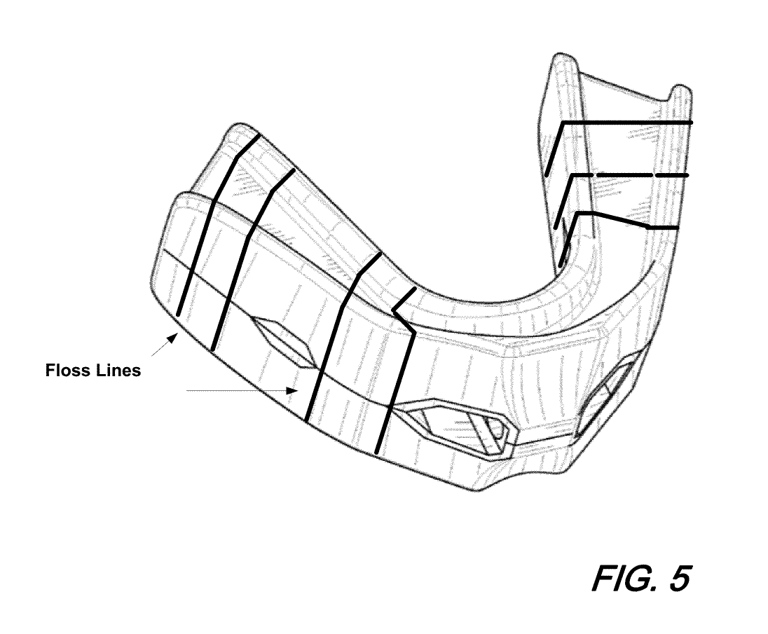

An additional feature of a tooth cleaning appliance according to the present disclosure may be realized with reference to FIG. 5 which shows a schematic perspective view of a tooth cleaning appliance including floss lines. The floss lines may be formed at the time of fabrication or time of use and are slits and/or gaps in the appliance material corresponding to gaps between a user's teeth. With such floss lines, a user may floss her teeth when the appliance is being used or otherwise within the user's mouth thereby eliminating the need to remove the appliance while performing additional, mechanical flossing. Of further advantage, such configurations permit the application of floss on the appliance in the floss lines prior to inserting into a mouth. Accordingly, any material between the teeth may be mechanically moved prior to application of any water jets—thereby improving the cleaning effect. Note further that while we have discussed that floss lines may be formed at the time of fabrication of an appliance, they may also be formed during use. In this manner, a user may form the floss lines—using for example floss—after an appliance is applied to the teeth. In this manner, the floss lines may be made to correspond exactly to a user's particular dental geometries.

Note further that these floss lines may be employed by a user to wrap the floss therearound, and then creating the actual floss lines. In this manner a user may floss her teeth while the appliance is being worn. As noted before, the figures are merely illustrations and not limiting. Accordingly, numerous broad embodiments of these concepts are contemplated as within the context of this disclosure.

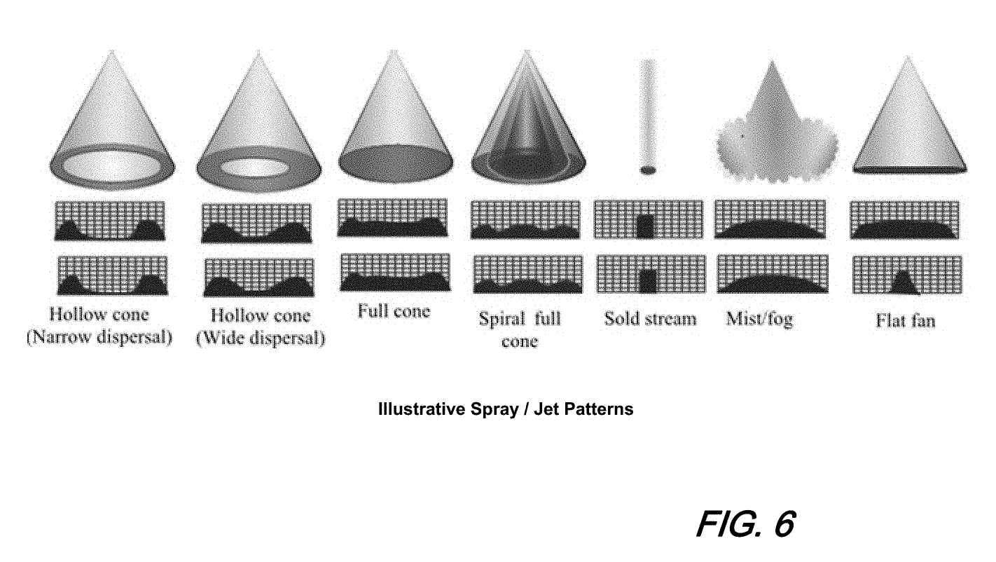

As noted previously, tooth cleaning appliances according to the present disclosure may clean areas between gums and teeth and advantageously clean gaps between teeth as well. To effect such cleaning, water jets may be produced by any number of appropriately configured “slits” or other outlets of the water channels running through the appliance. As may be readily appreciated, these slits may be different shape and/or orientation to produce a desired jet spray pattern to clean desired areas. In particular, these jets may be configured to produce a fan, stream, jet or other output configuration depending upon the particular areas to which such water is directed. Different shaped slits may be used to producing different shaped water streams that are illustratively shown in FIG. 6. Notably, any or all of the stream shapes may be employed as either continuous or pulsed jets to effect cleaning in a desirable manner.

When used, tooth cleaning appliances according to the present disclosure will generally require a user to bite down during use. As a result, there will exist a number of supporting and/or contact points between the appliance(s) and the teeth. As may be appreciated, when such biting takes place, those areas of the teeth in biting contact may not be exposed to any water jets. Advantageously however, appliances according to the present disclosure may be configured during manufacture such that any biting contact areas may be chosen so that they are easily and quickly cleaned by conventional, i.e., brushing or other techniques familiar to a user.

Additionally, and as previously noted, individual slits providing water exit from water channels may be curved or otherwise shaped to specifically spread or focus the water to areas or surfaces requiring particular water flow to provide satisfactory or desirable cleaning.

At this point we have primarily discussed cleaning using water jets and/or other known mechanical methods including brushing and flossing. Advantageously, tooth cleaning appliances according to the present disclosure are not so limited in their application. In particular, the appliance structures and processes/procedures shown and described may be used in conjunction with additional mechanical and/or ultrasonic cleaning—or combinations thereof.

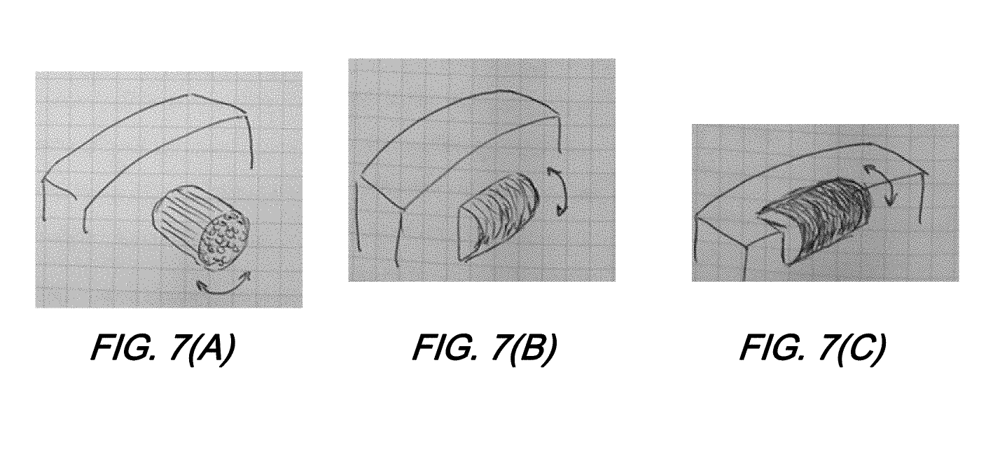

FIG. 7(a), FIG. 7(b) and FIG. 7(c) show a series of schematic diagrams depicting various brush arrangements/configurations that may advantageously be employed with tooth cleaning appliances according to the present disclosure. With simultaneous reference to FIGS. 7(a), 7(b) and 7(c) it may be observed that a brush may be configured as a rotating or fixed brush that mechanically agitates the surface(s) of the tooth/gums/spaces. Advantageously, brushes may be constructed such that they rotate in response to water moving through the water pipe, channels, or jets or combinations thereof. Additionally, such brushes may be located at any portion of the appliance in which it is included such that desired surfaces of the teeth/gums/spaces are brushed.

We note that brushes or other mechanical cleaning mechanisms employed in an appliance according to the present disclosure may include both active and passive devices. In other words, brushes may be merely passive structures that mechanically contact the teeth particularly during application/removal of the appliance. In other configurations, brushes may be active structures, that spin or otherwise mechanically clean the teeth/gums/spaces as a result of water flow or electrical motors or other electromechanical structures. Advantageously, such water or electrical or pneumatic motors may be made sufficiently small to conveniently fit within or on the appliance without any discomfort to the user. Furthermore, when such devices are pneumatic, the air employed in the pneumatic system may be further used to enhance the flow and/or jet action of the water streams to further enhance the cleaning effect of the appliance.

In addition to the water and mechanical cleaning that may be employed with appliances constructed according to the present disclosure, we now note that sonic/ultrasonic or related techniques may be also employed as well. More particularly, it is noted that these techniques may be effected by water agitation, built-in vibration mechanisms such as membranes produced during manufacture of an appliance that generate sonic/ultra sonic vibrations during operation. Lastly, it is noted that ultrasound transducers—such as a variety known in the art—may advantageously be affixed to an appliance constructed according to the present disclosure such that vibrations may be centrally generated, and then distributed throughout the appliance to further effect tooth/gum/space cleaning. As noted above, electromechanical structures including electrical and/or pneumatic and or water devices may be employed to generate sonic/ultrasonic action in addition to or in conjunction with mechanical actions such as those described previously. As also noted, control/power for these structures may be made sufficiently small so as to be comfortable to the user, while still maintaining efficacy. Finally, wiring such structures may be conveniently performed at fabrication time so that any wires for electrical power or conduits for pneumatic or water power may be conveniently run to appropriate portions of the appliance and any motors or actuators employed therein.

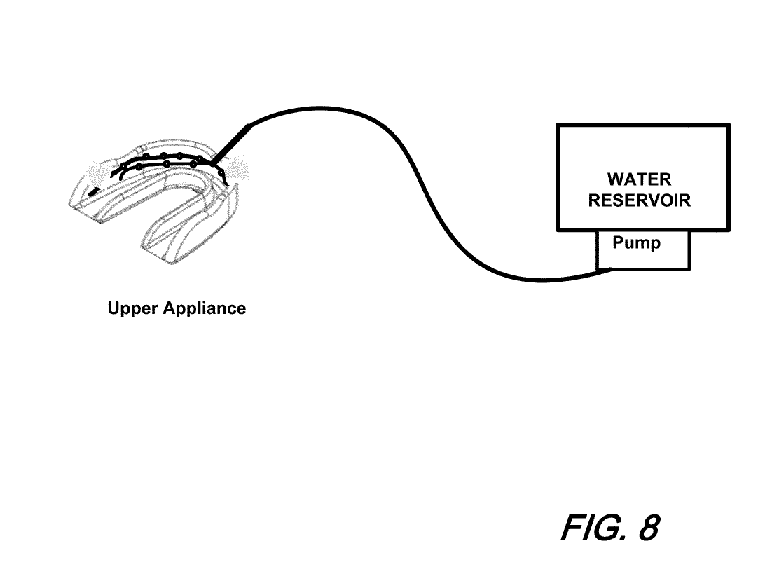

Finally, FIG. 8 is a schematic diagram illustrating an appliance according to the present disclosure as part of a dental hygiene system including water reservoir and pump to provide water to the appliance. As may be appreciated, any of a variety of reservoir and/or pump configurations are contemplated including electrical ones. Additionally, while the illustrative configuration shown includes a pump/reservoir, those skilled in the art will readily appreciate that an appliance according to the present disclosure may include piping that permits it hookup to a conventional faucet, for example. In such a configuration, no pump, reservoir would be required. Additionally, it is noted that the pump/reservoir or tap faucet configuration may also be used in conjunction with a pneumatic source that provides additional water pressure or alternative water jet characteristics as desired.

At this point, those skilled in the art will readily appreciate that while the methods, techniques and structures according to the present disclosure have been described with respect to particular implementations and/or embodiments, those skilled in the art will recognize that the disclosure is not so limited. Accordingly, the scope of the disclosure should only be limited by the claims appended hereto.

1. A tooth cleaning appliance comprising
a mouthpiece body having an inner portion, said inner portion forming a channel for receiving a user's teeth;
a series of liquid channels formed within the mouthpiece body;
a series of jets formed in the inner portion channel, said jets in liquid communication with the liquid channels.

2. The tooth cleaning appliance according to claim 1 further comprising:
an inlet pipe in liquid communication with the liquid channels, configured such that when a liquid is applied to the inlet pipe under pressure, the liquid flows through the liquid channels and exits one or more jets spraying teeth of the user.

3. The tooth cleaning appliance according to claim 1 further comprising:
a number of liquid outlets formed in the mouthpiece body for outputting liquid after contacting the user's teeth.

4. The tooth cleaning appliance according to claim 1 wherein the water channels are positioned such that they correspond in location to the user's teeth.

5. The tooth cleaning appliance according to claim 3 wherein the outlets are positioned such that they correspond in location to the user's teeth.

6. The tooth cleaning appliance according to claim 1 further comprising a series of floss lines for receiving dental floss, and positioned to correspond to spaces between the user's teeth such that the user may floss while the appliance is in place in the user's mouth.

7. The tooth cleaning appliance according to claim 1 wherein a given jet is configured to spray according to a spray pattern selected from the group consisting of: hollow cone narrow dispersal, hollow cone wide dispersal, full cone, spiral full cone, solid stream, mist/fog, and flat fan.

8. The tooth cleaning appliance according to claim 1 further comprising one or more rotatable brushes, said brushes in fluid communication with the liquid channels, said brushes configured to rotate when a fluid flows through the liquid channels, said brushes positioned to contact a surface of the user's teeth such that upon rotation, the user's teeth are scrubbed by the brush rotation.

9. The tooth cleaning appliance according to claim 1 further comprising a liquid reservoir and pump in fluid communication with the appliance liquid channels and configured to apply liquid under pressure to the tooth cleaning appliance.
